(19) United States
(12) Patent Application Publication
(10) Pub. No.: US 2007/0015674 A1
(43) Pub. Date: Jan. 18, 2007

(54) Low phosphate automatic dishwashing detergent composition

(76) Inventors: Xinbei Song, Cincinnati, OH (US); Brian Xiaoqing Song, Mason, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/478,390

(22) Filed: Jun. 29, 2006

Related U.S. Application Data
(60) Provisional application No. 60/695,372, filed on Jun. 30, 2005.

(51) Int. Cl. C11D 3/39

(52) U.S. Cl. 510/220

(57) ABSTRACT

A granular automatic dishwashing detergent composition with a density above 0.9 g/cm³, having low levels of phosphates and the addition of polymer builders with the composition is essentially free of bicarbonate.

### CROSS REFERENCE TO RELATED APPLICATION

This application claims benefit of and priority to U.S. Provisional Application Ser. No. 60/695,372, filed Jun. 30, 2005.

### FIELD OF THE INVENTION

The present invention relates to a granular automatic dishwashing composition comprising at least one dispersant polymer, at least one nonphosphate builder such as carbonate builder and a low level phosphate builder, even being substantially free of phosphate builder, wherein the composition is substantially free of bicarbonate and having a density greater than about 0.9 g/cm³.

### BACKGROUND OF THE INVENTION

In recent years, increased attention has been focused upon environmental pollution problems (e.g. water pollution). Phosphates have been identified as a contributing factor to eutrophication (i.e. promotion of algae growth) and considerable effort has been devoted to attempts at replacing all or at least some significant part of the alkaline condensed phosphates used in machine dishwashing detergents with chemicals that are more ecologically acceptable.

The art is replete with disclosures of nonphosphated granular cleaning compositions, often containing esoteric ingredients. Numerous processes have been disclosed for their making. In modern automatic dishwashing compositions a major inorganic builder ingredient, phosphate salts, either removed completely or limited create a void for cleaning and processing characteristics in such granular cleaning compositions for automatic dishwashing. Therefore there exists a need for an optimized automatic dishwashing detergent composition giving the desired cleaning while limiting the presence of phosphates in the composition.

### SUMMARY OF THE INVENTION

The present invention relates to a composition comprising: (a) from about 0.1 wt % to about 20 wt % by weight of the composition of a polymer dispersant selected the group consisting of polyacrylate, acrylate and maleate copolymers, acrylic acid and maleic acid copolymers, methacrylic acid and maleic anhydride; carboxylate and sulphonate monomers, and mixtures thereof; (b) from about 5 wt % to about 80 wt % by weight of the composition of carbonate salts; (c) from 0% to about 20 wt %, by weight of the composition of a phosphated builder; wherein the composition is a granular automatic dishwashing detergent having a density above 0.9 g/cm³ and is substantially free of bicarbonate

The present invention further relates to a method of using the composition to clean dishes.

### DETAILED DESCRIPTION OF THE INVENTION

As used herein, the term “dish” or “dishes” means any tableware (plates, bowls, glasses, mugs), cookware (pots, pans, baking dishes), glassware, silverware or flatware and cutlery, cutting board, food preparation equipment, etc. which is washed prior to or after contacting food, being used in a food preparation process and/or in the serving of food.

With reference to the polymers described herein, the term weight-average molecular weight is the weight-average molecular weight as determined using gel permeation chromatography according to the protocol found in Colloids and Surfaces A. Physico Chemical & Engineering Aspects, Vol. 162, 2000, pg. 107-121. The units are Daltons.

It should be understood that every maximum numerical limitation given throughout this specification would include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Density

The bulk density of the granular detergent compositions in accordance with the present invention is typically of at least 0.9 g/cm³, more usually at least 0.95 g/cm³ and more preferably from 0.95 g/cm³ to about 1.2 g/cm³.

Bulk density is measured by means of a simple funnel and cup device consisting of a conical funnel molded rigidly on a base and provided with a flap valve at its lower extremity to allow the contents of the funnel to be emptied into an axially aligned cylindrial cup disposed below the funnel. The funnel is 130 mm and 40 mm at its respective upper and lower extremities. It is mounted so that the lower extremity is 140 mm above the upper surface of the base. The cup has an overall height of 90 mm, an internal height of 87 mm and an internal diameter of 84 mm. Its nominal volume is 500 ml.

To carry out a measurement, the funnel is filled with powder by hand pouring, the flap valve is opened and powder allowed to overfill the cup. The filled cup is removed from the frame and excess powder removed from the cup by passing a straight edged implement e.g. a knife, across its upper edge. The filled cup is then weighed and the value obtained for the weight of powder doubled to provide the bulk density in g/cm³. Replicate measurements are made as required.

The particle size of the components of granular compositions in accordance with the invention should preferably be such that no more that 5% of particles are greater than 1.4 mm in diameter and not more than 5% of particles are less than 0.15 mm in diameter.

Polymer Dispersants

The present composition comprises from about 0.1 wt % to about 20 wt %, from about 1 wt % to about 15 wt %, from about 1 wt % to about 10 wt %, by weight of the automatic dishwashing detergent of a polymer dispersant.

Suitable polymer dispersants are generally at least partially neutralized in the form of their alkali metal, ammonium or other conventional cation salts. The alkali metals, especially sodium salts, are most preferred. While the weight average molecular weight of such dispersants can vary over a wide range, it preferably is from about 1,000 to about 500,000, more preferably is from about 2,000 to about 250,000, and most preferably is from about 3,000 to about 100,000. Nonlimiting examples of such materials are as follows. Sodium polyacrylate having a nominal molecular weight of about 4500, obtainable from Rohm & Haas under the tradename as ACUSOL® 445N, or acrylate/maleate copolymers such as are available under the tradename SOKALAN®, from BASF Corp., are preferred dispersants herein. The polymer dispersant commercially available under the trade name of SOKALAN® CP45 is a partially neutralized copolymer of methacrylic acid and maleic anhydride sodium salt is also suitable for use herein.

Other suitable polymer dispersants for use herein are copolymers containing both acrylic acid and maleic acid comonomers, such as AQUALIC® ML9 polymers (supplied by Nippon Shokubai Co. LTD)

Other suitable polymer dispersants for use herein are polymers containing both carboxylate and sulphonate monomers, such as ALCOSPERSE® polymers (supplied by Alco).

Water-Soluble Nonphosphate Salts

Water-soluble nonphosphate salts are typically materials which are moderately alkaline or, in any event, not highly alkaline, e.g., not materials such as pure sodium hydroxide or sodium metasilicate, although small amounts of such highly alkaline materials can be co-present with other salts. Salts useful herein include, for example, sodium carbonate, sodium citrate and mixtures thereof. Bicarbonate salts are not included in the compositions herein. Those familiar with the art of agglomeration will appreciate that physical modifications of the salts, e. g., to achieve increased surface area or more desirable particle shape, can be useful for improving the agglomeration characteristics.

The composition should be substantially free of bicarbonate salts. As used herein “substantially free” means that bicarbonate salts should be present at levels less than 1 wt % by weight of the composition. Preferably from 0 wt % to about 0.9 wt % by weight of the composition.

Preferred inorganic nonphosphate builder salts useful herein are the carbonate builders. Especially preferred by way of carbonate builder is anhydrous sodium carbonate, which, although it acts as a precipitating builder, is freely usable; for example, when present at levels of from about 10 wt % to about 80 wt % of the automatic dishwashing composition, preferably from about 10 wt % to about 60 wt % by weight of the automatic dishwashing composition. In one embodiment the weight ratio fo carbonate salts to polymer dispersant is from about 20:1 to about 6:1. Water-soluble sulfate salts may be optionally be present from about 0.05 wt % to about 50 wt % by weight of the automatic dishwashing composition.

Other suitable water-soluble nonphosphate salts herein are the citrates salt including, especially preferred are the sodium citrates, such as disodium citrate dihydrate. However, in one embodiment, the composition is substantially free of citrate salts. As used herein “substantially free” means that the citrate salts should be present at levels less than 1 wt % by weight of the composition, preferably from 0 wt % to about 0.9 wt % by weight of the composition.

The present compositions will typically comprise from about 10 wt % to about 99 wt %, preferably from about 10 wt % to about 90 wt %, preferably from about 10 wt % to about 75 wt % by weight of the composition of the water soluble nonphosphorus salts.

Phosphated Builder

Any suitable builder system comprising any suitable phosphated builder in any suitable amount or form may be used. In one embodiment a builder system may be present from 0% to about 20%, from 0% to about 10%, from 0% to about 6%, from about 1% to about 18%, from about 3% to about 17% by weight of the automatic dishwashing composition. Any conventional builder is suitable for use herein. For example, suitable builders include, but are not limited to: phosphate (such as sodium tripolyphosphate (STPP), potassium tripolyphosphate (KTPP), mixed sodium and potassium tripolyphosphate (SKTP), sodium or potassium or mixed sodium and potassium pyrophosphate), metal ion sequestrants such as aminopolyphosphonates, ethylenediamine tetramethylene phosphonic acid and diethylene triamine pentamethylene-phosphonic acid.

Silicates

The compositions of this invention may contain up to about 20 wt %, preferably from about 2 wt % to about 15 wt %, preferably from about 4 wt % to about 14 wt %, by weight of the automatic dishwashing composition of SiO₂ as a mixture of sodium or potassium silicates, preferably sodium silicates. These alkali metal silicate solids normally comprise from about 10 wt % to about 20 wt % of the composition. 1.0r to 3.6r silicates can be used although lower ratio silicates should be limited, 1.6r to 3.6r is preferred. A suitable silicate mixture is disclosed in U.S. Pat. No. 4,199,467.

From about 0 wt % to about 10 wt %, most preferably from about 2 wt % to about 8 wt % by weight of the formula is silicate solids from a hydrous silicate having a weight ratio of SiO₂:M₂O (M=Na or K) of from about 2 to about 3.2, preferably 2.4. This hydrous silicate at the indicated levels provides SiO₂ and can provide a desirable balance between agglomerating characteristics and the ability to form free-flowing, non-caking agglomerates while avoiding formation of excessive insolubles in certain formulas.

Lower moisture levels in general are desirable, e.g., it helps to use high solids levels wet silicates. It is also desirable to use as much two ratio (2.0r) silicate as possible for the remainder of the silicate, which can also be a mixture of 2.0r and 3.0r to 3.6r silicates, for best overall performance as far as spotting and filming (S/F) is concerned on metal surfaces, as disclosed in U.S. Pat. No. 4,199,468.

Adjunct Ingredients

Any suitable adjunct ingredient in any suitable amount or form may be used. For an example, a detergent active and/or rinse aid active, adjuvant, and/or additive, may be used in combination the corrosion inhibitor. Suitable adjunct ingredients include, but are not limited to, cleaning agents, surfactant other than the nonionic surfactants discussed above for example, anionic, cationic, amphoteric, zwitterionic, and mixtures thereof, chelating agent/sequestrant blend, bleaching system (for example, chlorine bleach, oxygen bleach, bleach activator, bleach catalyst, and mixtures thereof), enzyme (for example, a protease, lipase, amylase, and mixtures thereof), alkalinity source, water softening agent, secondary solubility modifier, thickener, acid, soil release polymer, dispersant polymer, thickeners, hydrotrope, binder, carrier medium, antibacterial active, detergent filler, abrasive, suds suppressor, defoamer, anti-redeposition agent, threshold agent or system, aesthetic enhancing agent (i.e., dye, colorants, perfume, etc.), oil, solvent, and mixtures thereof.

Surfactants

The methods described herein may use a composition comprising one or more suitable surfactants, optionally in a surfactant system, in any suitable amount or form. Suitable surfactants include anionic surfactants, cationic surfactants, nonionic surfactants, amphoteric surfactants, ampholytic surfactants, zwitterionic surfactants, and mixtures thereof. For example, a mixed surfactant system may comprise one or more different types of the above-described surfactants.

In one embodiment, the composition is substantially free of surfactants. As used herein “substantially free” means that surfactants should be present at levels less than 0.5 wt % by weight of the composition. Preferably from 0 wt % to about 0.4 wt % by weight of the composition.

Suitable nonionic surfactants also include, but are not limited to low-foaming nonionic (LFNI) surfactants. A LFNI surfactant is most typically used in an automatic dishwashing composition because of the improved water-sheeting action (especially from glassware) which they confer to the automatic dishwashing composition. They also may encompass non-silicone, phosphate or nonphosphate polymeric materials which are known to defoam food soils encountered in automatic dishwashing. The LFNI surfactant may have a relatively low cloud point and a high hydrophilic-lipophilic balance (HLB). Cloud points of 1% solutions in water are typically below about 32° C. and alternatively lower, e.g., 0° C., for optimum control of sudsing throughout a full range of water temperatures. If desired, a biodegradable LFNI surfactant having the above properties may be used.

A LFNI surfactant may include, but is not limited to: alkoxylated surfactants, especially ethoxylates derived from primary alcohols, and blends thereof with more sophisticated surfactants, such as the polyoxypropylene/polyoxyethylene/polyoxypropylene reverse block polymers. Suitable block polyoxyethylene-polyoxypropylene polymeric compounds that meet the requirements may include those based on ethylene glycol, propylene glycol, glycerol, trimethylolpropane and ethylenediamine, and mixtures thereof. Polymeric compounds made from a sequential ethoxylation and propoxylation of initiator compounds with a single reactive hydrogen atom, such as C₁₂₋₁₈ aliphatic alcohols, do not generally provide satisfactory suds control in Automatic dishwashing compositions. However, certain of the block polymer surfactant compounds designated as PLURONIC® and TETRONIC® by the BASF-Wyandotte Corp., Wyandotte, Mich., are suitable in Automatic dishwashing compositions.

The LFNI surfactant can optionally include a propylene oxide in an amount up to about 15% by weight. Other LFNI surfactants can be prepared by the processes described in U.S. Pat. No. 4,223,163. The LFNI surfactant may also be derived from a straight chain fatty alcohol containing from about 16 to about 20 carbon atoms (C₁₆-C₂₀ alcohol), alternatively a C₁₈ alcohol, condensed with an average of from about 6 to about 15 moles, or from about 7 to about 12 moles, and alternatively, from about 7 to about 9 moles of ethylene oxide per mole of alcohol. The ethoxylated nonionic surfactant so derived may have a narrow ethoxylate distribution relative to the average.

In certain embodiments, a LFNI surfactant having a cloud point below 30° C. may be present in an amount from about 0.01% to about 10%, or from about 0.5% to about 8% by weight, and alternatively, from about 1% to about 5% by weight of the composition.

Suitable anionic surfactants for use herein include, but are not limited to: alkyl sulfates, alkyl ether sulfates, alkyl benzene sulfonates, alkyl glyceryl sulfonates, alkyl and alkenyl sulphonates, alkyl ethoxy carboxylates, N-acyl sarcosinates, N-acyl taurates and alkyl succinates and sulfosuccinates, wherein the alkyl, alkenyl or acyl moiety is C₅-C₂₀, or C₁₀-C₁₈ linear or branched. Suitable cationic surfactants include, but are not limited to: chlorine esters and mono C₆-C₁₆ N-alkyl or alkenyl ammonium surfactants, wherein the remaining N positions are substituted by methyl, hydroxyethyl or hydroxypropyl groups. Suitable nonionic surfactants include, but are not limited to: low and high cloud point surfactants, and mixtures thereof. Suitable amphoteric surfactants include, but are not limited to: the C₁₂-C₂₀ alkyl amine oxides (for example, lauryldimethyl amine oxide and hexadecyl dimethyl amine oxide), and alkyl amphocarboxylic surfactants, such as MIRANOL® C2M. Suitable zwitterionic surfactants include, but are not limited to: betaines and sultaines; and mixtures thereof. Surfactants suitable for use are disclosed, for example, in U.S. Pat. No. 3,929,678; U.S. Pat. No. 4,223,163; U.S. Pat. No. 4,228,042; U.S. Pat. No. 4,239,660; U.S. Pat. No. 4,259,217; U.S. Pat. No. 4,260,529; and U.S. Pat. No. 6,326,341; EP 0414 549, EP 0,200,263, WO 93/08876 and WO 93/08874.

Chelating Agent

The detergent compositions herein may contain one or more chelating agents. Such chelating agents can be selected from the group consisting of amino carboxylates, amino phosphonates, polyfinctionally-substituted aromatic chelating agents and mixtures therein, all as hereinafter defined.

Amino carboxylates useful as chelating agents include ethylenediaminetetracetates, N-hydroxyethylethylenediaminetriacetates, nitrilo-tri-acetates, ethylenediamine tetrapro-prionates, triethylenetetraaminehexacetates, diethylenetriaminepentaacetates, and ethanoldi-glycines, alkali metal, ammonium, and substituted ammonium salts therein and mixtures therein.

Amino phosphonates are also suitable for use as chelating agents in the compositions of the invention when at lease low levels of total phosphorus are permitted in detergent compositions, and include ethylenediaminetetrakis (methylenephosphonates) as DEQUEST®. Preferred, these amino phosphonates to not contain alkyl or alkenyl groups with more than about 6 carbon atoms.

Polyfunctionally-substituted aromatic chelating agents are also useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelator for use herein is ethylenediamine disuccinate (“EDDS”), especially the [S,S] isomer as described in U.S. Pat. No. 4,704,233, Nov. 3, 1987, to Hartman and Perkins.

The compositions herein may also contain water-soluble methyl glycine diacetic acid (MGDA) salts (or acid form) as a chelant in an uncoated or coated form.

Zinc-Containing Materials

In one embodiment, particulate zinc-containing materials (PZCMs) and zinc-containing layered materials (ZCLMs), for treating glassware surfaces may be added as adjunct ingredients. Particulate zinc-containing materials (PZCMs) remain mostly insoluble within formulated compositions. Examples of PZCMs useful in certain non-limiting embodiments may include the following: inorganic material such as zinc aluminate, zinc carbonate, zinc oxide and materials containing zinc oxide (i.e., calamine), zinc phosphates (i.e., orthophosphate and pyrophosphate), zinc selenide, zinc sulfide, zinc silicates (i.e., ortho- and meta-zinc silicates), zinc silicofluoride, zinc borate, zinc hydroxide and hydroxy sulfate, and ZCLMs. PZCMs as glass corrosion protection agents require that the Zn²⁺ ion be chemically available without being soluble.

Many ZCLMs occur naturally as minerals. Common examples include hydrozincite (zinc carbonate hydroxide), basic zinc carbonate, aurichalcite (zinc copper carbonate hydroxide), rosasite (copper zinc carbonate hydroxide) and many related minerals that are zinc-containing. Natural ZCLMs can also occur wherein anionic layer species such as clay-type minerals (e.g., phyllosilicates) contain ion-exchanged zinc gallery ions. Other suitable ZCLMs include the following: zinc hydroxide acetate, zinc hydroxide chloride, zinc hydroxide lauryl sulfate, zinc hydroxide nitrate, zinc hydroxide sulfate, hydroxy double salts, and mixtures thereof. Natural ZCLMs can also be obtained synthetically or formed in situ in a composition or during a production process.

Commercially available sources of zinc carbonate include zinc carbonate basic (Cater Chemicals: Bensenville, Ill., USA), zinc carbonate (Shepherd Chemicals: Norwood, Ohio, USA), zinc carbonate (CPS Union Corp.: New York, N.Y., USA), zinc carbonate (Elementis Pigments: Durham, UK), and zinc carbonate AC (Bruggemann Chemical: Newtown Square, Pa., USA).

Any suitable PZCM or more particularly ZCLM in any suitable amount may be used. Suitable amounts of a PZCM include, but are not limited to: a range: from about 0.001% to about 20%, or from about 0.001% to about 10%, or from about 0.01% to about 7%, and alternatively, from about 0.1% to about 5% by weight of the composition.

Suds Suppressor

Any suitable suds suppressor in any suitable amount or form may be used. Suds suppressors suitable for use may be low foaming and include low cloud point nonionic surfactants (as discussed above) and mixtures of higher foaming surfactants with low cloud point nonionic surfactants which act as suds suppressors therein (see WO 93/08876; EP 0 705 324, U.S. Pat. No. 6,593,287, U.S. Pat. No. 6,326,341 and U.S. Pat. No. 5,576,281.

Suitable suds suppressor can be selected from the group consisting of silicon based antifoams, particularly conventional inorganic-filled polydimethylsiloxane antifoam agents, especially silica-filled polydimethylsiloxane antifoam agents as disclosed in U.S. Pat. No. 4,639,489 and U.S. Pat. No. 3,455,839. These and other suitable suds suppressor are commercially available under the tradenames of SILCOLAPSE® 431 and SILICONE EP® 6508 from ICI United States Inc., Wilmington, Del., U.S.A., RHODOSIL® 454 from Rhone-Poulenc Chemical Co., Monmouth Junction, N.J., U.S.A.; and SILKONOL AK® 100 commercially available from Wacker-Chemie G.m.b.H., Munich, Federal Republic of Germany.

In certain embodiments, one or more suds suppressors may be present in an amount from about 0% to about 30% by weight, or about 0.2% to about 30% by weight, or from about 0.5% to about 10%, and alternatively, from about 1% to about 5% by weight of the automatic dishwashing composition.

Enzyme

Any suitable enzyme and/or enzyme stabilizing system in any suitable amount or form may be used. Enzymes suitable for use include, but are not limited to: proteases, amylases, lipases, cellulases, peroxidases, and mixtures thereof. Amylases and/or proteases are commercially available with improved bleach compatibility. In practical terms, the composition may comprise an amount up to about 5 mg, more typically about 0.01 mg to about 3 mg by weight, of active enzyme per gram of the composition. Protease enzymes are usually present in such commercial preparations at levels sufficient to provide from 0.005 to 0.1 Anson units (AU) of activity per gram of composition, or 0.01%-1% by weight of a commercial enzyme preparation.

In certain embodiments, enzyme-containing compositions, may comprise from about 0.0001% to about 10%; from about 0.005% to about 8%; from about 0.01% to about 6%, by weight of the composition of an enzyme stabilizing system. The enzyme stabilizing system can be any stabilizing system that is compatible with the detersive enzyme. Such stabilizing systems can include, but are not limited to: calcium ions, boric acid, propylene glycol, short chain carboxylic acid, boronic acid, and mixtures thereof.

Bleaching System

Any suitable bleaching agent or system in any suitable amount or form may be used. Bleaching agents suitable for use include, but are not limited to: chlorine and oxygen bleaches. In certain embodiments, a bleaching agent or system may be present in an amount from about 0% to about 30% by weight, or about 1% to about 25% by weight, or from about 1% to about 20% by weight, and alternatively from about 2% to about 6% by weight of the composition.

Suitable bleaching agents include, but are not limited to: inorganic chlorine (such as chlorinated trisodium phosphate), organic chlorine bleaches (such as chlorocyanurates, water-soluble dichlorocyanurates, sodium or potassium dichloroisocyanurate dihydrate, sodium hypochlorite and other alkali metal hypochlorites); inorganic perhydrate salts (such as sodium perborate mono-and tetrahydrates and sodium percarbonate, which may be optionally coated to provide controlled rate of release as disclosed in GB 1466799 on sulfate/carbonate coatings), preformed organic peroxyacids, and mixtures thereof.

Peroxygen bleaching compounds can be any peroxide source comprising sodium perborate monohydrate, sodium perborate tetrahydrate, sodium pyrophosphate peroxyhydrate, urea peroxyhydrate, sodium percarbonate, sodium peroxide, and mixtures thereof. In other non-limiting embodiments, peroxygen-bleaching compounds may comprise sodium perborate monohydrate, sodium perborate tetrahydrate, sodium percarbonate, and mixtures thereof.

The bleaching system may also comprise transition metal-containing bleach catalysts, bleach activators, and mixtures thereof. Bleach catalysts suitable for use include, but are not limited to: the manganese triazacyclononane and related complexes (see U.S. Pat. No. 4,246,612, U.S. Pat. No. 5,227,084); Co, Cu, Mn and Fe bispyridylamine and related complexes (see U.S. Pat. No. 5,114,611); and pentamine acetate cobalt (III) and related complexes (see U.S. Pat. No. 4,810,410) at levels from 0% to about 10.0%, by weight; and alternatively, from about 0.0001% to about 1.0% by weight of the composition.

Typical bleach activators suitable for use include, but are not limited to: peroxyacid bleach precursors, precursors of perbenzoic acid and substituted perbenzoic acid; cationic peroxyacid precursors; peracetic acid precursors such as TAED, sodium acetoxybenzene sulfonate and pentaacetylglucose; pernonanoic acid precursors such as sodium 3,5,5-trimethylhexanoyloxybenzene sulfonate (iso-NOBS) and sodium nonanoyloxybenzene sulfonate (NOBS); amide substituted alkyl peroxyacid precursors (EP 0 170 386); and benzoxazin peroxyacid precursors (EP 0 332 294 and EP 0 482 807) at levels from 0% to about 10.0%, by weight; or from 0% to about 6%, by weight or from 0.1% to 1.0% by weight of the composition.

The detergent compositions of the present invention are not restricted as to manner of preparation. The granular compositions can be prepared in any manner that results in formation of a granular product form, preferably by agglomeration. The process described in U.S. Pat. No. 2,895,916, and variations thereof, are particularly suitable. Also particularly suitable is the process described in U.S. Pat. No. 5,614,485, U.S. Pat. No. 4,427,417 U.S. Pat. No. 5,914,307, U.S. Pat. No. 6,017,873 and U.S. Pat. No. 4,169,806.

Method of Use

The composition described herein can be used for the cleaning of soiled dishes by contacting the composition with a dish surface and then rinsing the dish surface with water. Optionally the dishes are allowed to dry either by heat or by air drying. Preferably the dishes are placed into an automatic dishwashing unit. The automatic dishwashing composition suitable herein can be dispensed from any suitable device, including but not limited to: dispensing baskets or cups, bottles (pump assisted bottles, squeeze bottles, etc.), mechanic pumps, multi-compartment bottles, capsules, multi-compartment capsules, paste dispensers, and single- and multi-compartment water-soluble pouches, and combinations thereof. For example, a multi-phase tablet, a water-soluble or water-dispersible pouch, and combinations thereof, may be used to deliver the composition to the desired dish surface.

### EXAMPLES

The following examples of automatic dishwashing compositions are provided for purposes of showing certain embodiments, and as such are not intended to be limiting in any manner.

Formulations

TABLE I

| | A | B | C | D | E |
|---|---|---|---|---|---|
| | Wt % | Wt % | Wt % | Wt % | Wt % |
| Polymer | 0.5 | 5 | 6 | 5 | 5 |
| dispersant¹ | | | | | |
| carbonate | 35 | 40 | 40 | 35-40 | 35-40 |
| sodium | 0 | 6 | 10 | 0-10 | 0-10 |
| tripolyphosphate | | | | | |
| 2.0r silicate | 6 | 6 | 6 | 6 | 6 |
| solids | | | | | |
| Bleach and | 4 | 4 | 4 | 4 | 4 |
| bleach | | | | | |
| activators | | | | | |
| enzymes | 0.3-0.6 | 0.3-0.6 | 0.3-0.6 | 0.3-0.6 | 0.3-0.6 |
| disodium citrate | 0 | 0 | 0 | 2-20 | 0 |
| dihydrate | | | | | |
| Nonionic | 0 | 0 | 0 | 0 | 0.8-5 |
| surfactant² | | | | | |
| Water, sulfate, | Balance | Balance | Balance | Balance | Balance |
| perfume, dyes | to 100% | to 100% | to 100% | to 100% | to 100% |
| and other | | | | | |
| adjuncts | | | | | |

¹Such as ACUSOL ® 445N available from Rohm & Haas or ALCOSPERSE ® from Alco.
²such as SLF-18 POLY TERGENT from the Olin Corporation.

All documents cited in the Detailed Description of the Invention are, in relevant part, incorporated herein by reference; the citation of any document is not to be construed 5 as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising:
(a) from about 0.1 wt % to about 20 wt % by weight of the composition of a polymer dispersant selected the group consisting of polyacrylate, acrylic acid and maleic acid copolymers, acrylate and maleate copolymers, methacrylic acid and maleic anhydride; carboxylate and sulphonate monomers, and mixtures thereof;
(b) from about 5 wt % to about 80 wt % by weight of the composition of carbonate salts;
(c) from 0% to about 20 wt %, by weight of the composition of a phosphated builder; wherein the composition is a granular automatic dishwashing detergent having a density above 0.9 g/cm³ and is substantially free of bicarbonate.

2. The composition of claim 1 further comprising about 1% to about 15% by weight of the composition of a bleaching system.

3. The composition of claim 1 wherein the carbonate salt is sodium carbonate.

4. The composition of claim 1 wherein the phosphated builder is sodium tripolyphosphate.

5. The composition of claim 1 wherein the polymer dispersant is selected as a polyacrylate with a weight average molecular weight from about 3,000 to about 100,000.

6. The composition of claim 1 further comprising up to about 20 wt % by weight of the composition of a silicate.

7. The composition of claim 1 further comprising up to about 5 mg of an enzyme.

8. The composition of claim 2 wherein the bleaching system comprises a transition metal-containing bleach catalyst.

9. The composition of claim 8 wherein the transition metal-containing bleach catalyst is a pentamine acetate cobalt (III) and related complexes.

10. A method of cleaning comprising the steps of:
(a) contacting the composition of claim 1 with dishes;
(b) rinsing the dishes with water.
